(19) United States
(12) Patent Application Publication
(10) Pub. No.: US 2021/0122188 A1
(43) Pub. Date: Apr. 29, 2021

(54) MOBILE CARRIAGE

(71) Applicant: Mitsubishi Electric Corporation, Tokyo (JP)

(72) Inventors: Yoshihiro MORIMOTO, Tokyo (JP); Toshihiro WADA, Tokyo (JP); Ryo KOJIMA, Tokyo (JP); Kenta KATO, Tokyo (JP)

(73) Assignee: Mitsubishi Electric Corporation, Tokyo (JP)

(21) Appl. No.: 17/043,684

(22) PCT Filed: Apr. 4, 2019
(86) PCT No.: PCT/JP2019/015039

§ 371 Date: Sep. 30, 2020

(30) Foreign Application Priority Data
May 16, 2018 (JP) 2018-094615

(51) Int. Cl. B60B 35/00; B60B 19/00; B62B 3/02; B62B 5/00

(52) U.S. Cl. CPC B60B 35/005; B60B 19/003; B60B 2900/551; B62B 5/0033; B62B 2301/08; B62B 3/02

(57) ABSTRACT

A mobile carriage includes a traveling part, a wheel, a bed, a displacement conversion part, and an elastic member. The wheel is provided on the traveling part. The bed is supported by the traveling part to be movable in a traveling direction of the traveling part. The displacement conversion part displaces the wheel relative to the traveling part in accordance with displacement of the bed relative to the traveling part. The elastic member applies a force to return the bed having moved relative to the traveling part to an initial position before the movement. The displacement conversion part displaces the wheel relative to the traveling part in a direction of inertial force acting on the bed.

### FIELD

The present invention relates to a mobile carriage including an anti-tipping mechanism.

### BACKGROUND

Mobile objects includes anti-tipping mechanism designed to perform control for preventing overturning by estimating inertial force applied to a mobile object on the basis of the position of the center of gravity or the acceleration.

Patent Literature 1 teaches control of a wheelbase so that the wheelbase becomes smaller when the traveling speed of a mobile robot is slow and that the wheelbase becomes larger when the traveling speed is fast, so as to increase the stability against overturning while the mobile robot is traveling.

### CITATION LIST

### Patent Literature

Patent Literature 1: Japanese Patent Application Laid-open No. 2009-090404

### SUMMARY

### Technical Problem

According to Patent Literature 1, in order to prevent overturning of the mobile robot, the mobile robot needs to measure the state, such as the speed, of the mobile object and include a power source for actively operating an anti-tipping mechanism in accordance with the measurement result. A sensor, a motor, an actuator, or the like is therefore essential, which makes the device larger and heavier. In addition, in Patent Literature 1, because the inertial force applied to the mobile robot is estimated from the weight and the acceleration of the mobile robot, it is essential that these state values be known. Thus, when an attempt is made to apply the technique of Patent Literature 1 to a mobile carriage to be loaded with goods, the robustness will be low because the position of the center of gravity and the inertial force change depending on the goods. Advanced robustness control capable of accommodating these changes will be necessary.

The present invention has been made in view of the above, and an object thereof is to provide a mobile carriage with an anti-tipping mechanism that passively operates in response to changes in acceleration and weight.

### Solution to Problem

To solve the above problem and achieve the object, the present invention provides a mobile carriage comprising: a traveling part; a wheel provided on the traveling part to allow the traveling part to travel; a bed supported by the traveling part, the bed being movable in a traveling direction of the traveling part; a displacement conversion mechanism to displace the wheel relative to the traveling part in accordance with displacement of the bed relative to the traveling part; and an elastic member to apply a force to return the bed having moved relative to the traveling part, to an initial position before the movement, wherein the displacement conversion mechanism displaces the wheel relative to the traveling part in a direction of inertial force acting on the bed.

### Advantageous Effects of Invention

According to the present invention, prevention of overturning of a mobile carriage can be achieved without sensors or actuators.

### BRIEF DESCRIPTION OF DRAWINGS

FIG. 1 is a conceptual diagram illustrating an external structure of a mobile carriage of a first embodiment.

FIG. 2 is a conceptual diagram illustrating an internal structure of the mobile carriage of the first embodiment.

FIG. 3 is a schematic diagram illustrating a conceptual structure of an anti-tipping mechanism of the mobile carriage of the first embodiment.

FIG. 4 is a conceptual diagram illustrating operation of the anti-tipping mechanism of the mobile carriage of the first embodiment.

FIG. 5 is a graph illustrating the relation between a loading weight and a difference between the moment in the overturn preventing direction and the moment in the overturning direction in a case with the anti-tipping mechanism of the first embodiment and in a case without the anti-tipping mechanism.

FIG. 6 is a conceptual diagram illustrating an internal structure of a mobile carriage according to a second embodiment.

FIG. 7 is a perspective view illustrating a conceptual configuration of a travel driving device of the mobile carriage of the second embodiment.

FIG. 8 is a conceptual diagram illustrating an internal structure of a mobile carriage of a third embodiment in a non-accelerated state.

FIG. 9 is a conceptual diagram illustrating the internal structure of the mobile carriage of the third embodiment in an accelerated state.

FIG. 10 is a conceptual diagram illustrating an internal structure of a mobile carriage of a fourth embodiment.

FIG. 11 is a conceptual diagram illustrating an internal structure of a mobile carriage of a fifth embodiment in a non-accelerated state.

FIG. 12 is a conceptual diagram illustrating the internal structure of the mobile carriage of the fifth embodiment in an accelerated state.

FIG. 13 is a conceptual diagram illustrating an external structure of a mobile carriage of a sixth embodiment.

FIG. 14 is a conceptual diagram illustrating an internal structure of the mobile carriage of the sixth embodiment.

FIG. 15 is a conceptual diagram illustrating an external structure of a mobile carriage of a seventh embodiment.

FIG. 16 is a conceptual diagram illustrating an internal structure of the mobile carriage of the seventh embodiment.

FIG. 17 is a conceptual diagram illustrating operation of an anti-tipping mechanism of the mobile carriage of the seventh embodiment.

FIG. 18 is a schematic diagram illustrating a conceptual structure of the anti-tipping mechanism of the mobile carriage of the seventh embodiment.

FIG. 19 is a conceptual diagram illustrating an internal structure of a mobile carriage of an eighth embodiment in a non-accelerated state.

FIG. 20 is a conceptual diagram illustrating the internal structure of the mobile carriage of the eighth embodiment in an accelerated state.

FIG. 21 is a perspective view illustrating a conceptual configuration of a travel driving device of the mobile carriage of the eighth embodiment.

FIG. 22 is a conceptual diagram illustrating an internal structure of the travel driving device of the mobile carriage of the eighth embodiment.

FIG. 23 is a plan view illustrating an external structure of a mobile carriage according to a ninth embodiment.

FIG. 24 is a conceptual diagram illustrating an internal structure of the mobile carriage of the ninth embodiment.

FIG. 25 is a perspective view illustrating an example of a bed guide of the mobile carriage of the ninth embodiment.

FIG. 26 is a perspective view illustrating another example of a bed guide of the mobile carriage of the ninth embodiment.

FIG. 27 is a plan view illustrating an example of a structure in a case where omni-wheels are applied to the mobile carriage of the ninth embodiment.

FIG. 28 is a plan view illustrating an example of a structure in a case where mecanum-wheels are applied to the mobile carriage of the ninth embodiment.

### DESCRIPTION OF EMBODIMENTS

A mobile carriage according to certain embodiments of the present invention will be described in detail below with reference to the drawings. Note that the present invention is not limited to the embodiments.

### First Embodiment

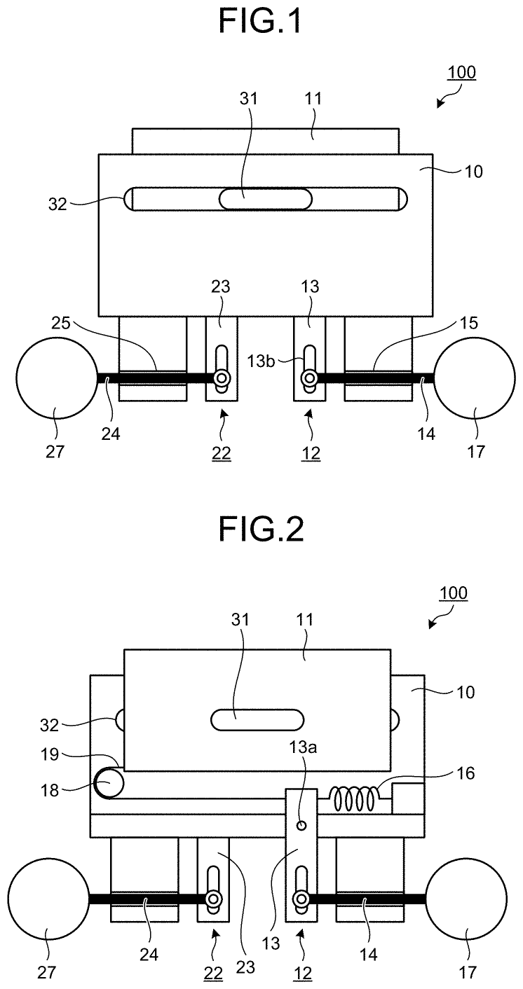

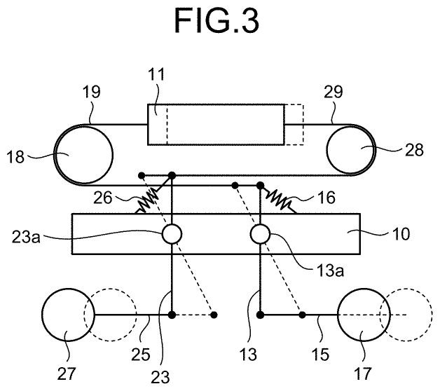

FIGS. 1 and 2 are conceptual diagrams illustrating a structure of a mobile carriage 100 of a first embodiment, in which FIG. 1 is a diagram illustrating an external structure, and FIG. 2 is a diagram illustrating an internal structure. FIG. 3 is a schematic diagram illustrating an anti-tipping mechanism of the mobile carriage 100 of the first embodiment. In FIG. 3, solid lines illustrate a state before acceleration of the mobile carriage 100, and broken lines illustrate a state after the acceleration. The mobile carriage 100 has a front part (left side in the figures) structure and a rear part (right side in the figures) structure that are symmetric about a center line, and has no distinctions in shape and structure in the front-rear direction. For convenience of explanation, leftward movement will be referred to as forward movement, rightward movement will be referred to as backward movement, a wheel 27 on the left will be referred to as a front wheel, and a wheel 17 on the right will be referred to as a rear wheel. The forward direction is a direction in which the mobile carriage 100 moves straight forward. The forward direction is the leftward direction in FIG. 1. The backward direction is a direction in which the mobile carriage 100 moves straight backward. The backward direction is the rightward direction in FIG. 1. The mobile carriage 100 includes three or more wheels. In FIG. 1, assume that the mobile carriage 100 includes two front wheels 27 and two rear wheels 17.

The mobile carriage 100 includes a traveling part 10, a bed 11, displacement conversion parts 12 and 22, elastic members 16 and 26, and the wheels 17 and 27. The mobile carriage 100 can include wheel support parts 14 and 24. The displacement conversion part 12 includes a link 13, and a wire 19. The displacement conversion part 12 can include a wire guide 18. The displacement conversion part 22 includes a link 23 and a wire 29 as illustrated in FIG. 3. The displacement conversion part 22 can include a wire guide 28. The displacement conversion part is also referred to as a displacement conversion mechanism.

The traveling part 10 has a box-like shape. The traveling part 10 has the bed 11 mounted thereon. Guide holes 32 are formed on both lateral sides of the traveling part 10. The guide holes 32 are recesses or holes. The guide holes 32 extend in the traveling direction of the traveling part 10. Guide protrusions 31 are formed on both lateral sides of the bed 11. The guide protrusions 31 are guided by the guide holes 32 and movable in the front-rear direction. Thus, the bed 11 is supported by the guide protrusions 31 and the guide holes 32 so that the bed 11 moves relative to the traveling part 10 in the traveling direction (the front-rear direction of the mobile carriage 100). The movement of the bed 11 in the other directions, however, is restricted. Note that the lateral sides are located in a direction perpendicular to the front-rear direction in the horizontal direction. The lateral sides of the bed 11 are located in the direction perpendicular to the front-rear direction of the bed 11 in the horizontal direction. In FIG. 1, the lateral sides are on the near side and the far side, of the drawing.

The traveling part 10 incudes the wheels 17 and 27. The traveling part 10 travels on the wheels 17 and 27. The traveling part 10 includes wheel guides 15 and 25. The wheel guides 15 and 25 are recesses or holes extending in the traveling direction of the traveling part 10. The wheel guides 15 and 25 guide the movements of the wheel support parts 14 and 24. A distal end of the wheel support part 14 supports the pair of rear wheels 17 so that the rear wheels 17 rotate. A proximal end of the wheel support part 14 is coupled to the link 13. A distal end of the wheel support part 24 supports the pair of front wheels 27 so that the front wheels 27 rotate. A proximal end of the wheel support part 24 is coupled to the link 23. The rear wheels 17 and the front wheels 27 are supported by the wheel support parts 14 and 24 so that the orientations thereof are fixed or changed. Thus, the wheel support parts 14 and 24 are supported by the wheel guides 15 and 25 so that the wheel support parts 14 and 24 move relative to the traveling part 10 in the traveling direction of the traveling part 10 (the front-rear direction of the mobile carriage 100). The movements of the wheel support parts 14 and 24 in the other directions are restricted.

The link 13 of the displacement conversion part 12 is attached to the traveling part 10 in such a manner that the link 13 turns about a shaft 13a. To “turn” means to make a circular movement in either of a forward direction and a reverse direction. One end of the wire 19 is fixed to the bed 11. The other end of the wire 19 is fixed to an upper end of the link 13. The movement of the wire 19 is guided by the wire guide 18. The wire guide 18 is attached to a front portion of the traveling part 10. The elastic member 16 is attached between the upper end of the link 13 and a rear portion of the traveling part 10. A proximal end of the wheel support part 14 is slidably coupled to a lower end of the link 13. Thus, an elongated hole 13b is formed on the lower end of the link 13. A proximal end of the wheel support part 14 is engaged with the elongated hole 13b. To “be engaged” means to fit. In other words, engagement means connection of elements with each other. The elastic member 16 is a tension spring. The elastic member 16 is attached to constantly generate a force in such a direction as to stretch the wire 19. The elastic member 16 applies tension to the wire 19.

The displacement conversion part 12 converts the displacement of the bed 11 relative to the traveling part 10 into the displacement of the wheels 17 relative to the traveling part 10. The mechanism of the displacement conversion part 12 is structured so that the amount of movement of the wheels 17 becomes equal to or larger than that of the bed 11. Thus, the amount of movement of the wheels 17 is equal to or larger than that of the bed 11.

The link 23 of the displacement conversion part 22 is attached to the traveling part 10 in such a manner that the link 23 turns about a shaft 23a as illustrated in FIG. 3. One end of the wire 29 is fixed to the bed 11. The other end of the wire 29 is fixed to an upper end of the link 23. The movement of the wire 29 is guided by the wire guide 28. The wire guide 28 is attached to the rear portion of the traveling part 10. The elastic member 26 is attached between the upper end of the link 23 and the front portion of the traveling part 10. A proximal end of the wheel support part 24 is slidably coupled to a lower end of the link 23. The elastic member 26 is a tension spring. The elastic member 26 is attached to constantly generate a force in such a direction as to stretch the wire 29. The elastic member 26 applies tension to the wire 29.

The displacement conversion part 22 converts the displacement resulting from the movement of the bed 11 relative to the traveling part 10, into the displacement resulting from the movement of the wheels 27 relative to the traveling part 10. The mechanism of the displacement conversion part 22 is structured so that the amount of movement of the wheels 27 becomes equal to or larger than that of the bed 11. Thus, the amount of movement of the wheels 27 is equal to or larger than that of the bed 11.

The elastic members 16 and 26 are tension springs. The elastic members 16 and 26 generate forces in directions opposite to each other. Thus, the elastic members 16 and 26 constantly generate forces to move the bed 11 back to the center. In other words, the elastic members 16 and 26 generate forces to return the bed 11, which moved relative to the traveling part 10, to the initial position before the movement. While the elastic members 16 and 26 are preferably as low in stiffness as possible, the elastic members 16 and 26 fully extended or compressed cannot produce the spring effect. Thus, the stiffness is preferably set so that the springs will not be fully extended or compressed when the greatest possible inertial force acts on the traveling part 10. The greatest inertial force may be generated by sudden acceleration, sudden deceleration, maximum loading of goods, and the like.

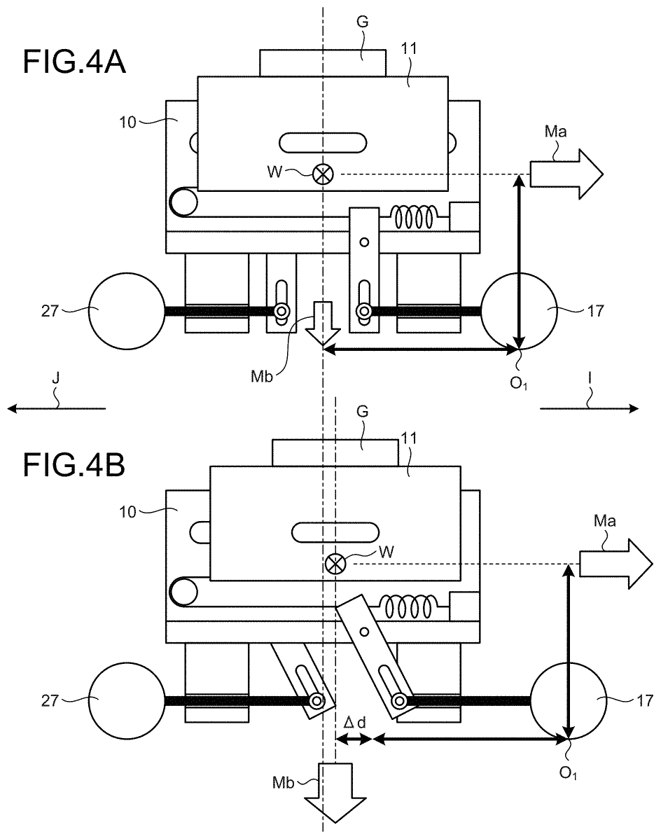

FIG. 4 is a conceptual diagram for explaining the operation when the anti-tipping mechanism of the first embodiment functions. FIG. 4 (A) illustrates a stop state or a non-accelerated state. FIG. 4 (B) illustrates an accelerated state. The mobile carriage 100 travels in the leftward direction in FIG. 4. When the mobile carriage 100 and the traveling part 10 are accelerated, the bed 11 including goods G loaded thereon undergoes the inertial force in a direction I opposite to the accelerating direction J of the bed 11. The bed 11 is then moved and displaced relative to the traveling part 10 in the direction I in which the inertial force is applied to the bed 11. This turns the link 13 in the counterclockwise direction in FIG. 4. The link 13 is connected with the bed 11 via the wire 19. The wheel support part 14 and the rear wheels 17 then move in the direction I opposite to the accelerating direction J. The direction I opposite to the accelerating direction J is the same direction as the inertial force. In FIG. 4, the amount of movement of the wheel support part 14 and the rear wheels 17 is Δd. Similarly, the link 23 is turned in the counterclockwise direction in FIG. 4. The link 23 is connected with the bed 11 via the wire 29. As a result, the wheel support part 24 and front wheels 27 move in the direction I opposite to the accelerating direction J. When the wheels 17 move backward by Δd, an overturning point O1 moves in the direction I opposite to the accelerating direction J. Thus, the moment Ma in the overturning direction does not change, but the moment Mb in the overturn preventing direction can be increased. The “overturning point” refers to a ground contact point of a wheel in a direction opposite to the accelerating direction J or the decelerating direction. In the case of acceleration during forward movement, the ground contact point of a rear wheel 17 corresponds to the overturning point O1. In the case of deceleration during forward movement, the ground contact point of a front wheel 27 corresponds to the overturning point O1. Reference character “W” represents the center of gravity of the mobile carriage 100 having the goods G loaded thereon. The moment Ma in the overturning direction is obtained on the basis of a height from the overturning point O1 to the center of gravity W and the inertial force. The moment Mb in the overturn preventing direction is obtained on the basis of the length from the overturning point O1 to the center of gravity W and the weight of the mobile carriage 100.

As the amount by which the displacement conversion parts 12 and 22 move the wheels 17 and 27 is larger relative to the amount of movement of the bed 11, the increase in the moment Mb in the overturn preventing direction is larger. Thus, the displacement conversion parts 12 and 22 preferably converts a displacement resulting from the movement of the bed 11 relative to the traveling part 10 into an increased displacement resulting from the movement of the wheels 17 and 27 relative to the traveling part 10.

FIG. 5 is a graph illustrating the relation between the loading weight Wa and a difference Mb-Ma between the moment Mb in the overturn preventing direction and the moment Ma in the overturning direction. The horizontal axis represents the loading weight Wa. The vertical axis represents the difference Mb-Ma between the moment Mb in the overturn preventing direction and the moment Ma in the overturning direction. The solid line represents a case with the anti-tipping mechanism of the first embodiment. The broken line represents a case without the anti-tipping mechanism. The moment in the overturn preventing direction has a positive value.

In the case of a carriage without the anti-tipping mechanism, the carriage is more likely to overturn as the loading weight Wa increases as shown by the broken line. Then, at a point when the loading weight Wa exceeds a certain weight, the moment Ma in the overturning direction becomes greater than the moment Mb in the overturn preventing direction, such that the mobile carriage overturns. In contrast, in the case of the mobile carriage with the anti-tipping mechanism according to the first embodiment, the amount of movement of the wheels 17 and 27 changes with the inertial force acting on the goods G and the bed 11 as shown by the solid line. Thus, even when the loading weight Wa increases, the moment Ma in the overturning direction and the moment Mb in the overturn preventing direction increase at the same time. This enables the mobile carriage 100 to be always stable with respect to acceleration and deceleration while traveling.

Note that the elastic members 16 and 26 only need to generate forces to return the bed 11 to the center and stretch the wires 19 and 29. Thus, compression springs may be used as the elastic members 16 and 26. Alternatively, non-linear springs whose spring stiffness changes with an increase in the amount of flexure may be used. For example, the spring stiffness of a non-linear spring increases with an increase in the amount of flexure thereof. Assuming that the maximum flexure amount and the elastic force of the non-linear spring are equivalent to those of a linear spring, the amount of movement of the wheels with an intermediate level of inertial force applied is larger than when the linear spring is used. In addition, for example, the spring stiffness of the non-linear spring decreases with an increase in the amount of flexure. The non-linear spring is capable of limiting the movement functions of the bed and the wheels under a small inertial force (during low acceleration/deceleration). While the anti-tipping function is truly in need, the non-linear spring is capable of producing the anti-tipping effect under a high acceleration or high deceleration condition. In addition, a damper may be mounted in parallel with the elastic members 16 and 26. Specifically, the damper is connected in parallel with the elastic members 16 and 26. This facilitates reduction of vibration generated when the anti-tipping function works as compared with a case where no damper is mounted. In addition, this can shorten the time taken to return to a normal state and reduce vibration.

As described above, according to the first embodiment, the displacement conversion parts 12 and 22 convert the relative displacement of the bed 11 relative to the traveling part 10 into the displacement resulting from the movement of the wheels having components in the same direction as the relative displacement. Thus, the amount of movement of the wheels passively changes depending on a change in the weight of goods loaded on the bed and traveling acceleration of the mobile carriage 100. Therefore, it becomes possible to “robustly” prevent overturning with respect to a change in traveling acceleration and a change in goods weight, without sensors and actuators. Note that “passively” is used to mean that the amount of movement of the wheels is changed without sensors and actuators.

### Second Embodiment

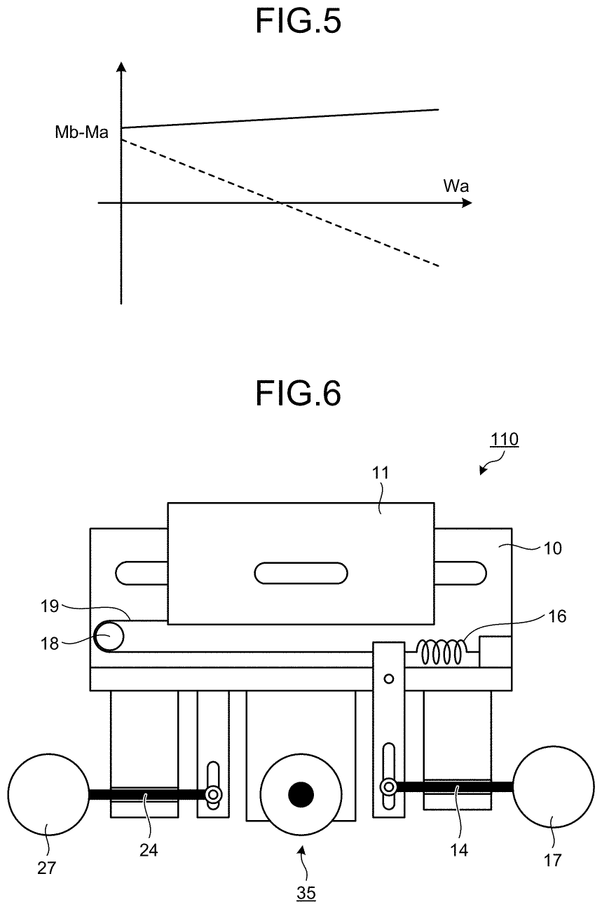

FIG. 6 is a conceptual diagram illustrating a mobile carriage 110 according to a second embodiment. The mobile carriage 110 of the second embodiment additionally includes a travel driving device 35 in addition to the components of the mobile carriage 100 of the first embodiment. The other components of the mobile carriage 110 of the second embodiment are the same as those of the mobile carriage 100 of the first embodiment, and redundant description thereof will not be repeated.

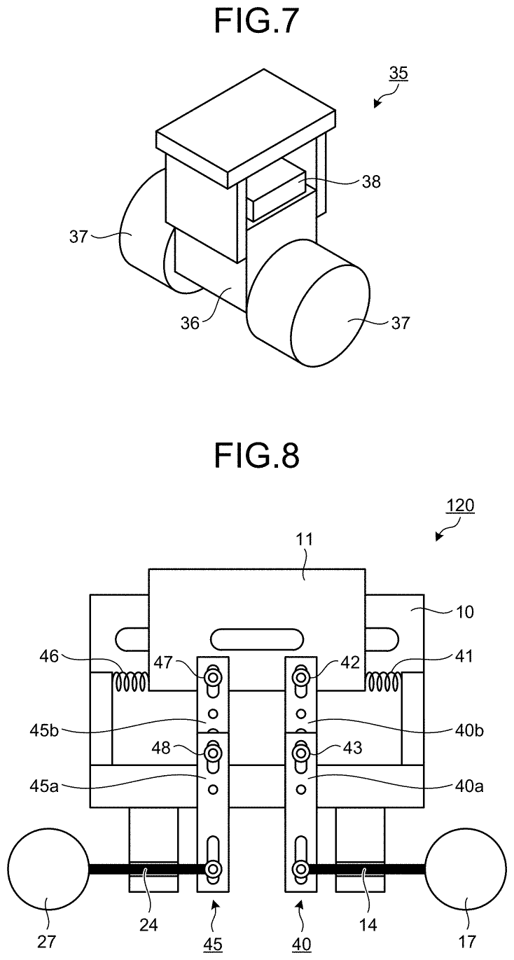

FIG. 7 is a perspective view illustrating a conceptual configuration of the travel driving device 35. The travel driving device 35 includes a travel driving motor 36 and a pair of travel driving wheels 37. The travel driving device 35 can include a battery 38. The travel driving device 35 is attached to the traveling part 10. The travel driving motor 36 uses power of the battery 38 to rotate the travel driving wheels 37.

According to the second embodiment, the travel driving device 35 is attached to the traveling part 10, and thus a self-propelled mobile carriage with the anti-tipping function presented in the first embodiment can be achieved.

### Third Embodiment

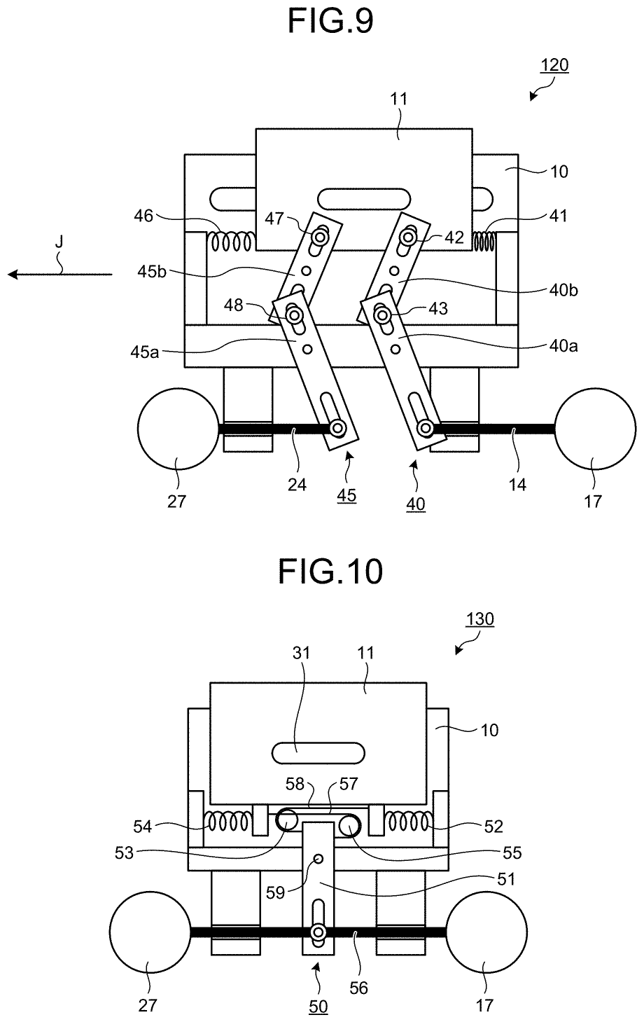

FIGS. 8 and 9 are conceptual diagrams illustrating a structure of a mobile carriage 120 according to a third embodiment, in which FIG. 8 illustrates a non-accelerated state, and FIG. 9 illustrates an accelerated state. Components that can have the same functions as those illustrated in FIGS. 1 and 2 will be represented by the same reference numerals, and redundant description thereof will not be repeated.

In the third embodiment, a displacement conversion part 40 includes two sliding links 40a and 40b. A displacement conversion part 45 includes two sliding links 45a and 45b. An upper end of the sliding link 40b is slidably coupled to a shaft 42. The shaft 42 is fixed to the bed 11. A lower end of the sliding link 40b is slidably coupled to a shaft 43. The shaft 43 is fixed to the traveling part 10. An upper end of the sliding link 40a is slidably coupled to the shaft 43. A lower end of the sliding link 40a is slidably coupled to a proximal end of the wheel support part 14. An upper end of the sliding link 45b is slidably coupled to a shaft 47. The shaft 47 is fixed to the bed 11. A lower end of the sliding link 45b is slidably coupled to a shaft 48. The shaft 48 is fixed to the traveling part 10. An upper end of the sliding link 45a is slidably coupled to the shaft 48. A lower end of the sliding link 45a is slidably coupled to a proximal end of the wheel support part 24. An elastic member 41 is provided between a rear portion of the bed 11 and the rear portion of the traveling part 10. An elastic member 46 is provided between a front portion of the bed 11 and the front portion of the traveling part 10. The elastic members 41 and 46 each have one end connected with the bed 11. The elastic members 41 and 46 each have the other end connected with the traveling part 10. The sliding links 40b and 45b are first links. The sliding links 40a and 45a are second links.

As illustrated in FIG. 9, when the mobile carriage 120 is accelerated leftward, the bed 11 undergoes inertial force in the direction opposite to the accelerating direction J. The bed 11 then moves backward relative to the traveling part 10. As a result, the sliding links 40b and 45b turn about the shafts 43 and 48, respectively, in the clockwise direction. The sliding links 40a and 45a turn about the shafts 43 and 48, respectively, in the counterclockwise direction. The front wheels 27 and the rear wheels 17 then move backward from the positions thereof before acceleration. Thus, in a manner similar to the first embodiment, the overturning point moves backward. Then, although the moment in the overturning direction does not change, the moment in the overturn preventing direction increases.

According to the third embodiment, the structure for connection between the bed 11 and the displacement conversion parts 40 and 45 can be achieved by a simpler structure than that in the first embodiment, which can make the device structure smaller.

### Fourth Embodiment

FIG. 10 is a conceptual diagram illustrating a configuration of a mobile carriage 130 according to a fourth embodiment. Components that can have the same functions as those illustrated in FIGS. 1 and 2 will be represented by the same reference numerals, and redundant description thereof will not be repeated.

In a manner similar to the first embodiment, the bed 11 is movable in the traveling direction (the front-rear direction of the mobile carriage 130) relative to the traveling part 10. The front wheels 27 and the rear wheels 17 are connected with a wheel support part 56. The number of wheel support part 56 is one, for example. The front wheels 27, the rear wheels 17, and the wheel support part 56 are formed integrally with each other. Note that the front wheels 27 and the rear wheels 17 are rotatable relative to the wheel support part 56. The wheel support part 56 is coupled to the displacement conversion part 50. The displacement conversion part 50 includes a link 51, and wires 57 and 58. The displacement conversion part 50 can include wire guides 53 and 55. An elastic member 52 is provided between the rear portion of the traveling part 10 and the rear portion of the bed 11. An elastic member 54 is provided between the front portion of the traveling part 10 and the rear portion of the bed 11.

A lower end of the link 51 is coupled to the wheel support part 56. The link 51 is coupled to the wheel support part 56 in such a manner that the link 51 is slidable relative to the wheel support part 56. The link 51 turns about a shaft 59. The shaft 59 is fixed to the traveling part 10. One end of the wire 58 is connected with the rear portion of the bed 11. The other end of the wire 58 is connected with an upper end of the link 51 via the wire guide 53. One end of the wire 57 is connected with the front portion of the bed 11. The other end of the wire 57 is connected with the upper end of the link 51 via the wire guide 55.

In FIG. 10, when the mobile carriage 130 is accelerated leftward, the bed 11 undergoes inertial force in the rightward direction. The bed 11 then moves rightward relative to the traveling part 10. As a result, in FIG. 10, the link 51 turns about the shaft 59 in the counterclockwise direction. The link 51 is connected with the bed 11 via the wire 58. In addition, the wheel support part 56 and the wheels 17 and 27 move rightward. Thus, in a manner similar to the first embodiment, the overturning point moves backward. Then, although the moment in the overturning direction does not change, the moment in the overturn preventing direction can be increased.

According to the fourth embodiment, the wheel support part and the displacement conversion part can be integrated together. As a result, the mobile carriage 130 is achieved with a simper structure. The structure of the mobile carriage 130 can thus be made smaller.

### Fifth Embodiment

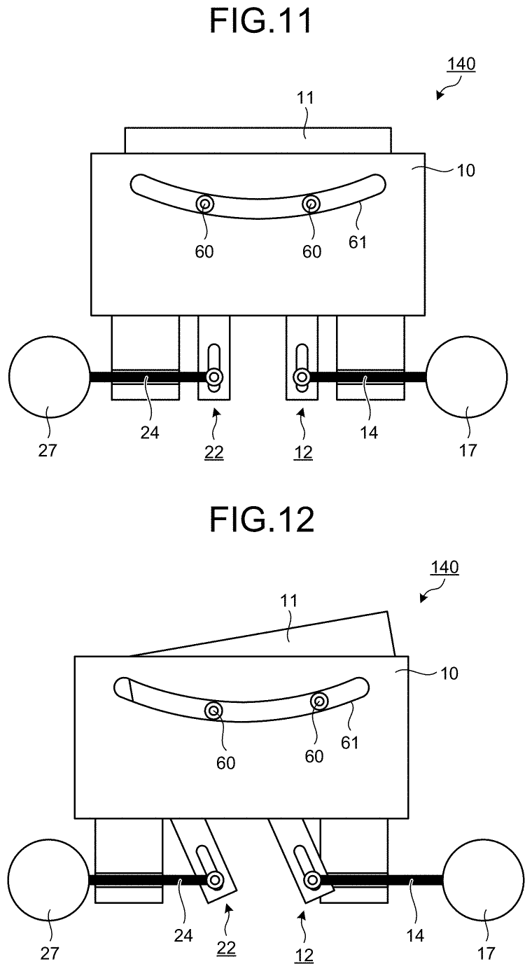

FIGS. 11 and 12 are conceptual diagrams illustrating a structure of a mobile carriage 140 according to a fifth embodiment, in which FIG. 11 illustrates a stopped state or a non-accelerated state, and FIG. 12 illustrates an accelerated state. Components that can have the same functions as those illustrated in FIGS. 1 and 2 will be represented by the same reference numerals, and redundant description thereof will not be repeated. The difference between the mobile carriage 140 of the fifth embodiment and the mobile carriage 100 of the first embodiment lies only in a mechanism for guiding the bed 11 relative to the traveling part 10. Note that the structures in FIG. 4, 8, or 10 or the like can be employed for the structure of connections from the displacement conversion parts 12 and 22 to the bed 11. Thus, this structure is not illustrated in FIGS. 11 and 12.

Two guide protrusions 60 and 60 are formed on each of lateral sides of the bed 11. The two guide protrusions 60 and 60 are spaced apart from each other. Guide holes 61 having an arc-like shape that is convex downward are formed on both lateral sides of the traveling part 10. In other words, guide holes 61 having an arc-like shape having its center of curvature located above in the vertical direction are formed on both lateral sides of the traveling part 10. Downward refers to toward the wheels 17 and 27 from the mobile carriage 140. In addition, upward refers to opposite of downward. The guide holes 61 may have a groove-like shape. With such a guide mechanism, the bed 11 is most stable when the bed 11 is at the center position. In addition, when inertial force acts on the goods and the bed 11, the bed 11 comes into such a posture that the goods fall down against the accelerating direction or the decelerating direction of the traveling part 10. Thus, unlike parallel movement of the bed 11, the bed is inclined to be opposite to the direction in which the goods would fall out. Therefore, this can further prevent loaded goods from slipping down.

According to the fifth embodiment, the bed 11 moves relative to the traveling part 10 along the guide holes 61 having an arc-like shape that is convex downward. Therefore, this can further prevent loaded goods from slipping down.

### Sixth Embodiment

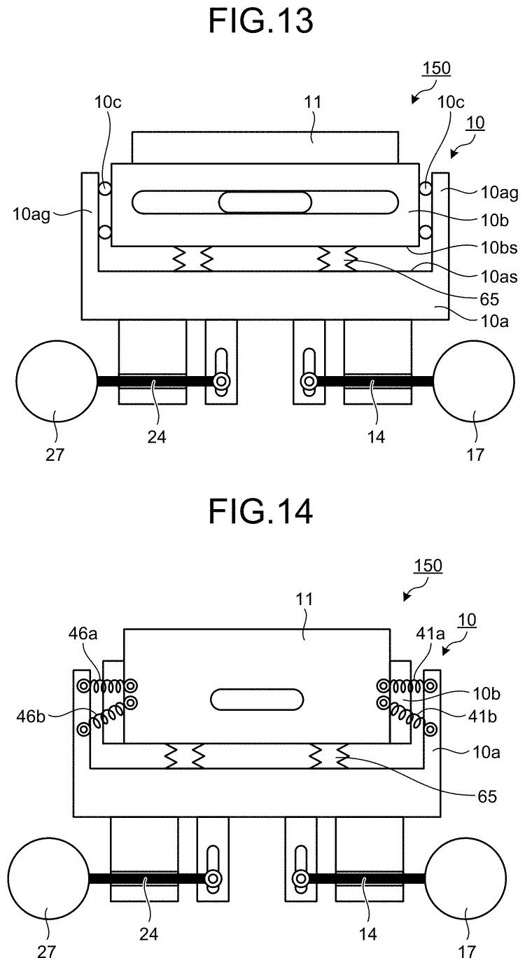

FIGS. 13 and 14 are conceptual diagrams illustrating a structure of a mobile carriage 150 of a sixth embodiment, in which FIG. 13 is a diagram illustrating an external structure, and FIG. 14 is a diagram illustrating an internal structure. Components that can have the same functions as those illustrated in FIGS. 1 and 2 will be represented by the same reference numerals, and redundant description thereof will not be repeated. The differences between the mobile carriage 150 of the sixth embodiment and the mobile carriage 100 of the first embodiment lie only in the structure of the traveling part 10 and a mechanism for moving the bed 11 relative to the traveling part 10. Note that the structures in FIG. 4, 8, or 10 or the like can be employed for the structure of connections from the displacement conversion parts 12 and 22 to the bed 11. Thus, this structure is not illustrated in FIGS. 13 and 14.

The traveling part 10 is defined by a base part 10a and a guide part 10b. The guide part 10b is restricted by vertical guides 10c so that the guide part 10 moves vertically relative to the base part 10a. Elastic members 65 are provided between a bottom face 10bs of the guide part 10b and a top face 10as of the base part 10a. The face 10as faces the face 10bs. The guide part 10b is mounted on the base part 10a with the elastic members 65 therebetween.

The vertical guide 10c is described, for example, as being a roller disposed between the guide part 10b and guiding portions 10ag of the base part 10a. The base part 10a includes the guiding portions 10ag. A “roller” is a component that has a spherical or columnar shape or the like, and converts a sliding friction into a rolling friction. In FIG. 13, the guiding portions 10ag extend upward from front and rear ends of the base part 10a. The guide part 10b is disposed between the two guiding portions 10ag. The guide part 10b is guided by the guiding portions 10ag with the vertical guides 10c therebetween.

The elastic members 16 and 26 generate forces to move the bed 11 back to its initial position before acceleration. The mobile carriage 150 includes elastic members 41a, 41b, 46a, and 46b in addition to the elastic members 16 and 26 illustrated in FIG. 1. The elastic member 41a is attached between a rear portion of the base part 10a and the rear portion of the bed 11. The elastic member 41a is attached in parallel with the traveling direction of a vehicle (horizontally, for example), for example. The elastic member 41b is attached between the rear portion of the base part 10a and the rear portion of the bed 11. The elastic member 41b is attached at an angle with respect to the traveling direction of the vehicle, for example. The connecting point between the elastic member 41b and the bed 11 is at a position upper than the connecting point between the elastic member 41b and the base part 10a. The elastic member 46a is attached between a front portion of the base part 10a and the front portion of the bed 11. The elastic member 46a is attached in parallel with the traveling direction of the vehicle (horizontally, for example), for example. The elastic member 46b is attached between the front portion of the base part 10a and the front portion of the bed 11. The elastic member 46b is attached at an angle with respect to the traveling direction of the vehicle, for example. The connecting point between the elastic member 46b and the bed 11 is at a position upper than the connecting point between the elastic member 46b and the base part 10a. The elastic members 41a, 41b, 46a, and 46b are pivotably connected at the connecting points with the base part 10a and the connecting points with the bed 11. The elastic member 41a and the elastic member 41b may be equal to or different in spring stiffness from each other. In the case of the mobile carriage 150, the elastic members 41a and 41b are equal in spring stiffness to each other.

With this structure, the amounts of depression of the bed 11 and the guide part 10b change with a change in the weight of goods loaded on the bed 11. “Depression” means lowering due to weight. The elastic members 41a and 46a are attached without inclination (horizontally, for example). Thus, the depression of the bed 11 and the guide part 10b inclines the elastic members 41a and 46a. In addition, as the loading weight is heavier and the amounts of depression of the bed 11 and guide part 10b are larger, the spring effect lowers. In contrast, the elastic members 41b and 46b are attached at an angle. Thus, the depression of the bed 11 and the guide part 10b brings the elastic members 41b and 46b to a horizontal position. In addition, as the loading weight is heavier and the amounts of depression of the bed 11 and guide part 10b are larger, the spring effect increases. Thus, when the loading weight is light, the elastic members 41a and 46a are dominant in the combined spring stiffness that supports the bed 11. In contrast, when the loading weight is heavy, the elastic members 41b and 46b are dominant in the combined spring stiffness that supports the bed 11.

As described above, in the sixth embodiment, a plurality of elastic members are arranged so as to provide different spring stiffnesses in the traveling direction of the traveling part 10, depending on the vertical position of the bed 11. This enables the spring stiffnesses to vary depending on the loading weight. In addition, this prevents a system including the bed 11 and the elastic members 41a, 41b, 46a, and 46b from entering an elastic vibration mode. In addition, this enables the spring stiffnesses to vary depending on the loading weight. Thus, as described above, effects similar to those in the case where non-linear springs are used for the elastic members 16 and 26 can be produced. Thus, the movement of the bed 11 and the wheels 17 and 27 can be made small in a low acceleration range, and the movement of the bed 11 and the wheels 17 and 27 can be made large in medium and high speed ranges.

The elastic members may be provided at one vertical position. In addition, more elastic members may further be used. In addition, the sixth embodiment may be applied to the second to fourth embodiments above.

### Seventh Embodiment

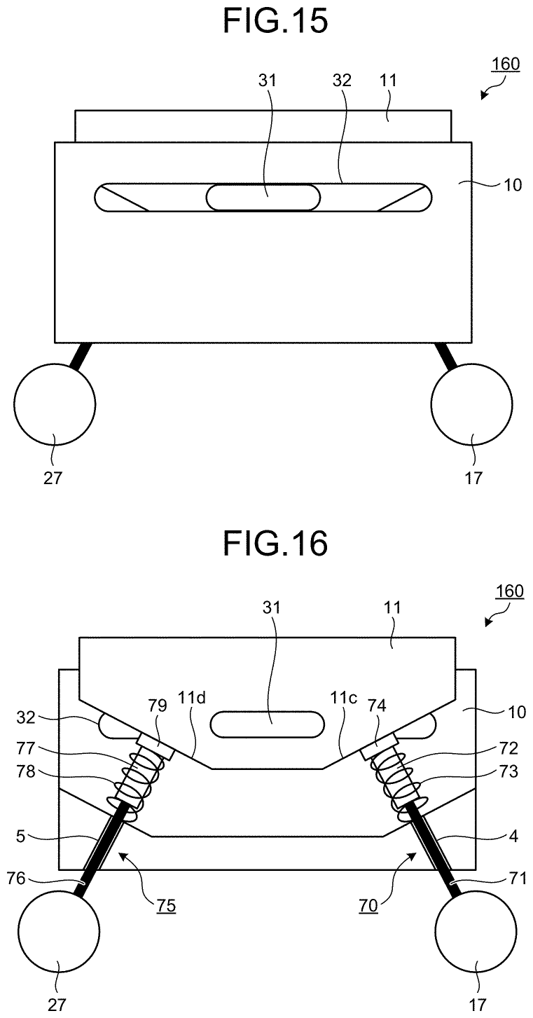

FIGS. 15 and 16 are conceptual diagrams illustrating an example of a structure of a mobile carriage 160 of a seventh embodiment, in which FIG. 15 is a diagram illustrating an external structure, and FIG. 16 is a diagram illustrating an internal structure. The mobile carriage 160 includes a traveling part 10, a bed 11, displacement conversion parts 70 and 75, wheel support parts 71 and 76, elastic members 73 and 78, and wheels 17 and 27. The displacement conversion part 70 includes a shaft 72 and a bed contact portion 74. The displacement conversion part 75 includes a shaft 77 and a bed contact portion 79.

In a manner similar to the first embodiment, the bed 11 is supported to be movable relative to the traveling part 10 in the traveling direction (the front-rear direction). The bed 11 is supported by the guide protrusions 31 and the guide holes 32. In addition, the movement of the bed 11 in the other directions is restricted.

The traveling part 10 includes wheel guides 4 and 5. The wheel guides 4 and 5 guide the movements of the wheel support parts 71 and 76. The wheel guide 4 is inclined backward with respect to the gravity direction (downward) from the center of the traveling part 10 so that the wheelbase becomes wider. The wheel support part 71 moves along the inclination direction of the wheel guide 4. The wheel guide 5 is inclined frontward with respect to the gravity direction from the center of the traveling part 10 so that the wheelbase becomes wider. The wheel support part 76 moves along the inclination direction of the wheel guide 5. A wheelbase refers to the length from the center of a front tire to the center of a rear tire in side view of a car. The wheel support parts 71 and 76 are movable in the direction along the wheel guides 4 and 5. In addition, the movements of the wheel support parts 71 and 76 in the other directions are restricted. The wheel support part 71 is a first wheel support part. The wheel support part 76 is a second wheel support part. The wheel support part 71 guides the rear wheels 17 such that the rear wheels move in a direction perpendicular to an inclined face 11c. The wheel support parts 76 guides the front wheels 27 such that the front wheels move in a direction perpendicular to an inclined face 11d.

A distal end of the wheel support part 71 supports the rear wheels 17 so that the rear wheels 17 rotate. A distal end of the wheel support part 76 supports the front wheels 27 so that the front wheels 27 rotate. The rear wheels 17 and the front wheels 27 are supported by the wheel support parts 71 and 76 so that the orientations thereof are fixed or changed.

The shaft 72 of the displacement conversion part 70 connects the wheel support part 71 with the bed contact portion 74. The shaft 72 is a first shaft. The elastic member 73 is provided in parallel with the shaft 72. Alternatively, the elastic member 73 is provided surrounding the shaft 72. The elastic member 73 is a first elastic member. The inclined face 11c and the inclined face 11d are formed on the bottom side of the bed 11. The inclined face 11c is a first inclined face, for example. The inclined face 11d is a second inclined face, for example. The inclined face 11c is inclined so that the position of the bottom face of the bed 11 becomes higher in a backward direction from the center. The inclined face 11d is inclined so that the position of the bottom face of the bed 11 becomes higher in a forward direction from the center. The movement of the bed contact portion 74 in the normal direction relative to the inclined face 11c of the bed 11 is restricted. The bed contact portion 74 freely moves along the inclined face 11c relative to the inclined face 11c. A structure of the bed contact portion 74 can use, for example, a rotatable ball embedded in a contact face. The bed contact portion 74 is pressed against the inclined face 11c of the bed 11 by the elastic member 73. The bed 11 moves in the traveling direction relative to the traveling part 10 by the guide protrusions 31 and the guide holes 32. In addition, the movement of the bed 11 relative to the traveling part 10 causes the bed contact portion 74 to move in the front-rear direction along the inclined face 11c. The bed contact portion 74 is a first bed contact portion.

The shaft 77 of the displacement conversion part 75 connects the wheel support part 76 with the bed contact portion 79. The shaft 77 is a second shaft. The elastic member 78 is provided in parallel with the shaft 77. Alternatively, the elastic member 78 is provided surrounding the shaft 77. The elastic member 78 is a second elastic member. The movement of the bed contact portion 79 in the normal direction relative to the inclined face 11d of the bed 11 is restricted. The bed contact portion 79 freely moves along the inclined face 11d relative to the inclined face 11d. A structure of the bed contact portion 79 may use, for example a rotatable ball embedded in a contact face. The bed contact portion 79 is pressed against the inclined face 11d of the bed 11 by the elastic member 78. The bed 11 moves in the traveling direction relative to the traveling part 10 by the guide protrusions 31 and the guide holes 32. In addition, the movement of the bed 11 relative to the traveling part 10 causes the bed contact portion 79 to move in the front-rear direction along the inclined face 11d. The bed contact portion 79 corresponds to a second bed contact portion.

Note that the shaft 72 and the wheel support part 71 converts the displacement of the bed 11 relative to the traveling part 10 into the increased displacement resulting from the movement of the wheels 17. Thus, the shaft 72 and the wheel support part 71 may be structured to extend and contract with the movement of the bed 11 relative to the traveling part 10. Either one of the shaft 72 and the wheel support part 71 may extend and contract. Alternatively, both of the shaft 72 and the wheel support part 71 may extend and contract. Similarly, the shaft 77 and the wheel support part 76 converts the displacement of the bed 11 relative to the traveling part 10 into the increased displacement resulting from the movement of the wheels 27. Thus, the shaft 77 and the wheel support part 76 may be structured to extend and contract with the movement of the bed 11 relative to the traveling part 10. Hereinafter, the description will be provided on the assumption that both of the shafts 72 and 77 and the wheel support parts 71 and 76 extend and contract.

The elastic members 73 and 78 presses the bed 11 in the front-rear direction via the bed contact portions 74 and 79, respectively. As a result, the bed 11 undergoes a force such that the bed 11 is positioned at the initial position in a normal state. The initial position is the center of the mobile carriage 160 in the front-rear direction, for example. While the elastic members 73 and 78 is preferably as low in stiffness as possible, the elastic members 73 and 78 that are fully extended or compressed cannot produce the spring effect. Thus, the stiffnesses of the elastic members 73 and 78 are preferably set so that the springs will not be fully extended or compressed when the greatest possible inertial force acts on the traveling part 10. Note that the greatest possible inertial force acts on the traveling part 10 due to, for example, the acceleration at sudden acceleration, the acceleration at sudden deceleration, and the maximum load of goods.

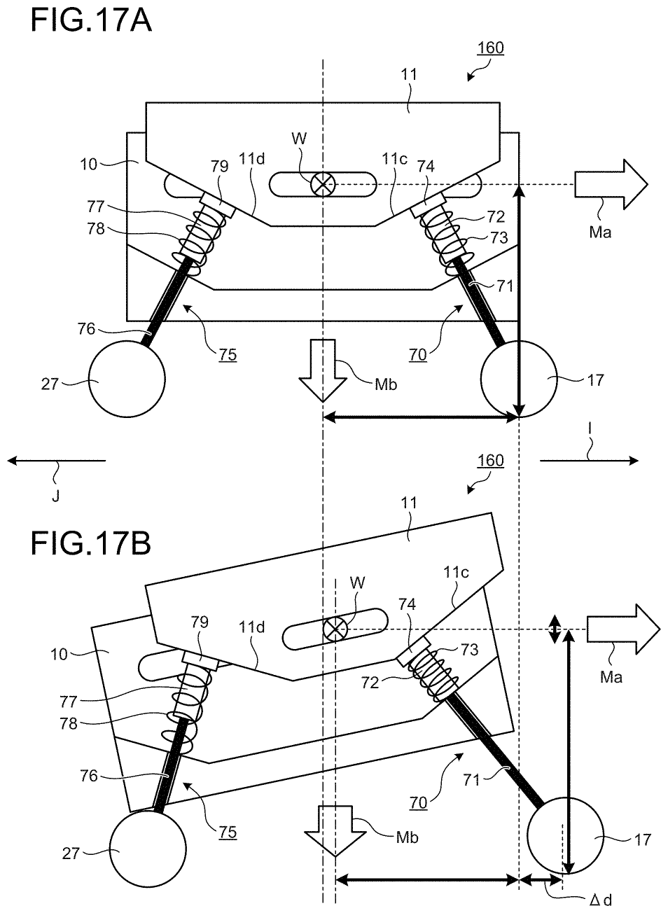

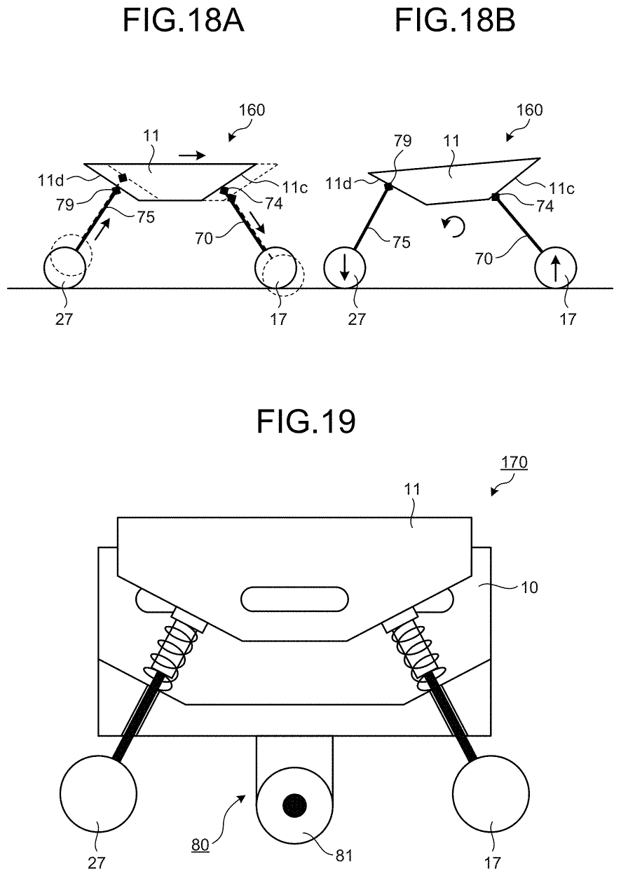

FIG. 17 is a conceptual diagram for explaining the operation when the anti-tipping mechanism of the seventh embodiment functions. FIG. 17 (A) illustrates a stop state or a non-accelerated state. FIG. 17 (B) illustrates an accelerated state. FIG. 18 is a schematic diagram illustrating an anti-tipping mechanism of the mobile carriage 160 of the seventh embodiment. The assumption is that the mobile carriage 160 travels in the leftward (forward) direction in the drawing. When the mobile carriage 160 travels, the traveling part 10 accelerates. As a result, the bed 11 loaded with goods undergoes inertial force in the direction I opposite to the accelerating direction J. The bed 11 then moves backward relative to the traveling part 10. Then, as illustrated by broken lines in FIG. 18 (A), the bed contact portion 79 moves upward along the inclined face 11d. In addition, the bed contact portion 74 moves downward along the inclined face 11c. The shaft 77 and the wheel support part 76 become shorter as a whole. The front wheels 27 then retract toward the traveling part 10. In addition, the front wheels 27 are displaced backward. In contrast, the shaft 72 and the wheel support part 71 extend as a whole. The rear wheels 17 are then pushed out relative to the traveling part 10. In addition, the rear wheels 17 are displaced backward. The displacement of the rear wheel 17 is Δd. As a result, as illustrated in FIG. 17 (B) and FIG. 18 (B), the mobile carriage 160 tilts with the front part being lower than the rear part.

As a result of the backward displacement of the rear wheels 17, the moment Ma in the overturning direction slightly increases or decreases. In contrast, the moment Mb in the overturn preventing direction significantly increases. As a result, in terms of the total moment, moment Mb in the overturn preventing direction can be increased by an amount corresponding to the displacement Δd of the rear wheels 17. Note that the moment Ma in the overturning direction slightly increases or decreases by the angles of the wheel support parts 71 and 76 or the influence of the design on the center of gravity of the mobile carriage 160.

For example, inclining the wheel support parts 71 and 76 or the inclined faces 11c and 11d by 45 degrees or more with respect to the gravity center direction easily achieves a design capable of preventing overturning without depending on the quantity or the height of the goods to be loaded. Design is made so that an increase in the moment Mb in the overturn preventing direction becomes equal to or larger than an increase in the moment Ma in the overturning direction without depending on the quantity and the height of goods assumed to be loaded. The wheel support parts 71 and 76 or the inclined faces 11c and 11d are inclined by 45 degrees or more with respect to the gravity direction. As a result, an increase in the moment Mb in the overturn preventing direction is likely to be equal to or larger than an increase in the moment Ma in the overturning direction. In addition, the effect of preventing overturning is likely to be produced. With the structure of the seventh embodiment, the mobile carriage 160 takes such a posture that goods fall down in the accelerating direction J or the decelerating direction of the mobile carriage 160. Thus, unlike parallel movement, the bed 11 is inclined to be opposite to the direction in which the goods would fall out. This facilitates preventing the loaded goods from slipping down. In addition, the bed 11 tilts against the direction of force acting on the bed 11. Thus, when the mobile carriage 160 travels on an inclined face, the displacement of the wheels and the tilt of the bed described above also occur in the case of a change in the gravity direction. Therefore, the mobile carriage 160 can also produce an effect of automatically keeping the bed horizontal.

Note that compression springs are typically used as the elastic members 73 and 78. Tension springs, however, may be used as the elastic members 73 and 78. Alternatively, the aforementioned non-linear springs may be used as the elastic members 73 and 78. In addition, a damper may be mounted in parallel with elastic members as the elastic members 73 and 78.

### Eighth Embodiment

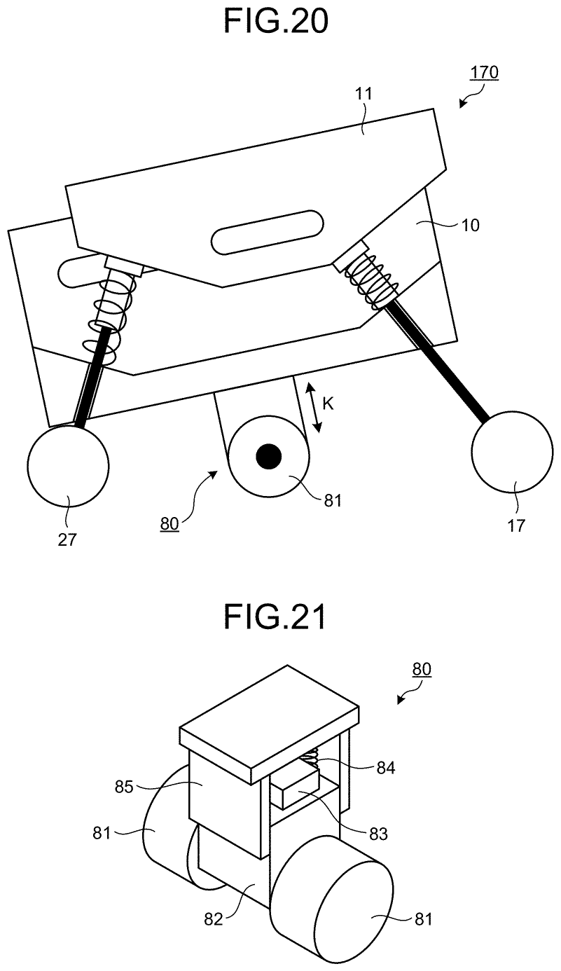

FIGS. 19 and 20 are conceptual diagrams illustrating an example of structure of a mobile carriage 170 according to an eighth embodiment, in which FIG. 19 illustrates a stopped state or a non-accelerated state, and FIG. 20 illustrates an accelerated state. The mobile carriage 170 of the eighth embodiment additionally includes a travel driving device 80 in addition to the components of the mobile carriage 160 of the seventh embodiment. The other components of the mobile carriage 170 of the eighth embodiment are the same as those of the mobile carriage 160 of the seventh embodiment, and redundant description thereof will not be repeated.

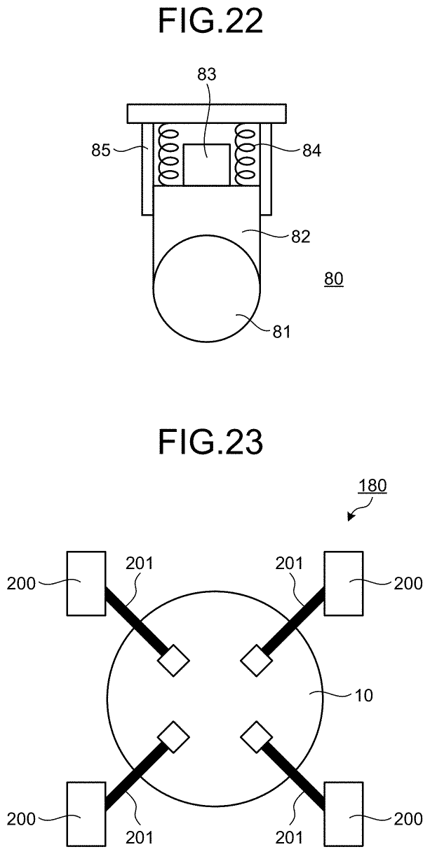

FIG. 21 is a perspective view illustrating a conceptual configuration of the travel driving device 80. FIG. 22 is a side view illustrating a conceptual configuration of the travel driving device 80. The travel driving device 80 is attached to the traveling part 10. The travel driving device 80 includes travel driving wheels 81 and a travel driving motor 82. In the eighth embodiment, the travel driving wheels 81 is provided in a pair. The travel driving device 80 can include a battery 83, an elastic member 84, and a motor guide 85. The travel driving motor 82 and the travel driving wheels 81 are movable in the vertical direction of the travel driving wheels 81 relative to the traveling part 10 by the motor guide 85. The vertical direction of the travel driving wheels 81 is the direction indicated by an arrow K illustrated in FIG. 20. The direction of the arrow K is the same as the vertical direction of the mobile carriage 170 when the mobile carriage 170 does not tilt. The travel driving motor 82 and the travel driving wheels 81 are guided so that the movement thereof in the other directions is restricted. The other directions mean the directions other than the direction of the arrow K. The elastic member 84 is to press the travel driving wheels 81 against a travel surface. Thus, the travel driving device 80 is capable of transmitting power to the travel surface regardless of the posture of the traveling part 10.

According to the eighth embodiment, the travel driving device 80 is attached to the traveling part 10, and thus a self-propelled mobile carriage with the anti-tipping function presented in the seventh embodiment can be achieved.

### Ninth Embodiment

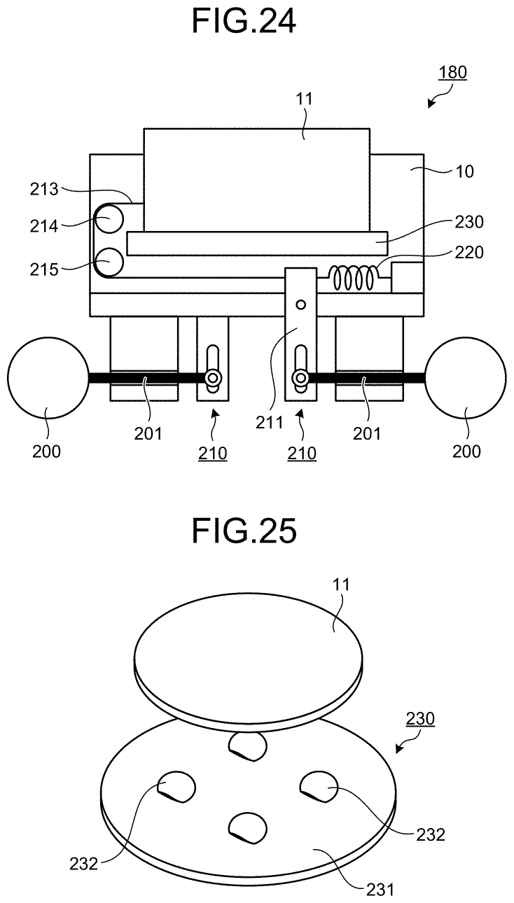

FIGS. 23 and 24 are conceptual diagrams illustrating an example of a structure of a mobile carriage 180 of a ninth embodiment, in which FIG. 23 is a plan view, and FIG. 24 is a diagram illustrating an internal structure. The mobile carriage 180 of the ninth embodiment is movable in all directions.

The mobile carriage 180 includes a traveling part 10, a bed 11, a plurality of wheels 200, a plurality of wheel support parts 201, a plurality of displacement conversion parts 210, and a plurality of elastic members 220. In the ninth embodiment, four wheels 200, four wheel support parts 201, four displacement conversion parts 210, and four elastic members 220 are provided. The mobile carriage 180 can includes a bed guide 230. The bed guide 230 is attached to the traveling part 10. The bed guide 230 guides the movement of the bed 11 relative to the traveling part 10. The bed guide 230 can freely move the bed 11 in the in-plane direction. Note that the plane corresponds to the surface of the bed 11 loaded with goods.

FIG. 25 illustrates a first example of the bed guide 230, and FIG. 26 illustrates a second example of the bed guide 230. In the first example, the bed guide 230 includes a bed guide base 231 and a plurality of ball casters 232. Casters refer to small wheels that are attached to legs of furniture, bags, and the like. Ball casters are casters for freely carrying heavy goods over 360-degree directions. Ball casters have freedom of movement in the in-plane direction. Note that the “plane” corresponds to a floor surface, for example. The ball casters 232 may be anything capable of guiding the bed 11 in the in-plane direction. The ball casters 232 can be replaced with omnidirectional wheels, air bearings, or lubricated surfaces, for example. Examples of the omnidirectional wheels include omni-wheels and mecanum-wheels. A lubricated surface is a surface with a very small friction. In the second example, the bed guide 230 includes two linear motion guides 233 and 234 that guide the bed 11 in directions perpendicular to each other.

As illustrated in FIG. 23, the four wheel support parts 201 are provided on the traveling part 10. The four wheel support parts 201 extend radially in four directions from the traveling part 10. The wheels 200 are attached to distal ends of the wheel support parts 201. Omnidirectional wheels are used as the wheels 200. Ball casters, omni-wheels, mecanum-wheels, or the like are used as the wheels 200.

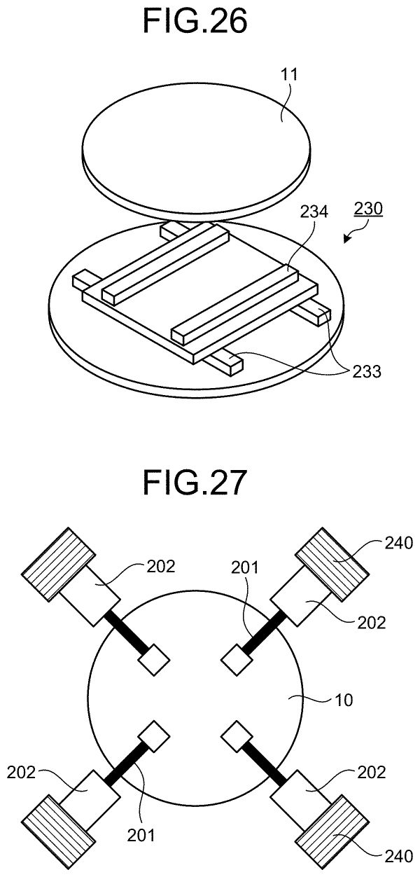

FIG. 27 is a diagram illustrating an example of a structure in a case where omni-wheels 240 are used as the wheels 200. An omni-wheel has a function of providing movement in multiple directions including the movement in the front-rear direction by rotation of a body (wheel) about a shaft and the movement in the left-right direction by rotation of barrel-shaped rollers (barrels) arranged on the circumference of the body (wheel). An omni-wheel 240 including a motor 202 includes a wheel and a plurality of driven wheels (barrels). The driven wheels are arranged along the circumferential direction of the wheel. The driven wheels each have a rotation axis in a direction perpendicular to the radial direction of the wheel. The omni-wheels 240 are movable in all directions without moving the shafts of the wheels. When the omni-wheels 240 are used, four wheel support parts 201 are arranged radially from the center of the carriage at regular intervals of 90 degrees. When the rotation axes of the wheel support parts 201 and those of the wheels of the omni-wheels 240 are in alignment with each other, the rotating direction of the driven wheels of the omni-wheels 240 can be matched with the moving direction of the omni-wheels 240.

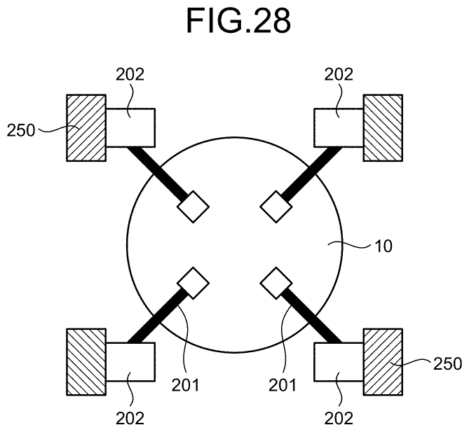

FIG. 28 is a diagram illustrating an example of a structure in a case where mecanum-wheels 250 are used as the wheels 200. A mecanum-wheel includes a wheel having a surface (on the circumference) covered with barrel-shaped rollers (barrels) inclined by 45 degrees with respect to the wheel axis. A mecanum-wheel is capable of making movements in the directions of 45 degrees because the barrel-shaped rollers are free, in addition to the same movements as those of the wheels of related art. Four mecanum-wheels each including a motor 202 achieve movement in all directions by rotation of the wheels and the movements of the barrel-shaped rollers by adjusting the rotating directions and speed control of the four motors 202. A mecanum-wheel 250 includes a plurality of driven wheels (barrels) attached onto the circumference of the wheel at an angle of 45 degrees. The mecanum-wheels 250 are movable in all directions without moving the shafts of the wheels. When the mecanum-wheels 250 are used as well, four wheel support parts 201 are arranged radially from the center of the carriage at regular intervals of 90 degrees. In addition, when the rotation axes of the wheels of the mecanum-wheels 250 are tilted by 45 degrees with respect to the wheel support parts 201, the rotating direction of the driven wheels of the mecanum-wheels 250 can be matched with the moving direction of the mecanum-wheels 250.

Four wheel support parts 201 are radially arranged on the mobile carriage 180. Each of the wheel support parts 201 is connected with a displacement conversion part 210 and an elastic member 220. Each of the displacement conversion parts 210 includes a link 211 and a wire 213. Each of the displacement conversion parts 210 can include wire guides 214 and 215. The displacement conversion parts 210 achieves functions similar to those of the displacement conversion part 12 of the first embodiment. Each of the elastic members 220 is attached between an upper end of the link 211 and the traveling part 10. Each of the elastic members 220 achieves functions similar to those of the elastic member 16 of the first embodiment. The displacement conversion parts 210 and the elastic members 220 determine the directions of the turning axes of the links 211, the directions of arrangement of the elastic members 220, the guiding directions of the wires 213, and the like so as to correspond to the respective directions of arrangement of the wheel support parts 201.

According to the ninth embodiment, the bed 11 and the wheels 200 can be moved in any direction in response to inertial force acting in any direction upon acceleration or deceleration in any direction. Thus, prevention of overturning is achieved for the movement in all directions caused by acceleration or deceleration.

In a case where non-directional wheels are used as the wheels 200, the arrangement of the wheel support parts 201 is not limited. Non-directional wheels are, for example, ball casters. Thus, the arrangement of the wheel support parts 201 and the anti-tipping mechanism parts is modified or added depending on the directions in which overturning is to be prevented. This achieves overturn prevention in all directions and also enables weighting of the anti-tipping effect in the directions in which overturning is to be prevented.

In addition, the travel driving device 35 of the second embodiment or the travel driving device 80 of the eighth embodiment may also be attached to the mobile carriage 180 of the ninth embodiment to achieve a self-propelled mobile carriage. In particular, in a structure including the omni-wheels 240 illustrated in FIG. 27 or the mecanum-wheels 250 illustrated in FIG. 28, the direction of movement caused by the movements of the wheel support parts 201 and the wheels during overturn preventing operation match with the rotating direction of the driven wheels. Thus, driving motors 202 can be directly mounted on the omni-wheels 240 or the mecanum-wheels 250 to achieve a self-propelled mobile carriage. This structure enables the anti-tipping mechanism and the self-propelled mobile carriage to be achieved at the same time with a minimum structure without the need for additionally providing driving wheels.

Note that, the explanation of FIG. 24 is made as to a case where the displacement conversion mechanism of the first embodiment illustrated in FIG. 1 is used. In the case where omnidirectional wheels are used, however, the displacement conversion part of the third embodiment illustrated in FIG. 8 or the displacement conversion part of the seventh embodiment illustrated in FIG. 16 may be applied. In addition, the arc-shaped guides 60 and 61 illustrated in FIG. 12 may be applied to the mobile carriage 160 of the seventh embodiment illustrated in FIG. 15, the mobile carriage 170 of the eighth embodiment illustrated in FIG. 19, or the mobile carriage 180 of the ninth embodiment illustrated in FIG. 24. In addition, the structure of the sixth embodiment illustrated in FIG. 13 may be applied to the mobile carriage 160 of the seventh embodiment illustrated in FIG. 15 or the mobile carriage 170 of the eighth embodiment illustrated in FIG. 19

The structures presented in the embodiments above are examples of the present invention, and can be combined with other known technologies. In addition, part of the structures can be partly omitted or modified without departing from the scope of the present invention.

### REFERENCE SIGNS LIST

10 traveling part; 10a base part; 10b guide part; 10c vertical guide; 11 bed; 11c, 11d inclined face; 12, 22 displacement conversion part; 13, 23 link; 14, 24 wheel support part; 16, 26 elastic member; 17 wheel (rear wheel); 18, 28 wire guide; 19, 29 wire; 27 wheel (front wheel); 31 guide protrusion; 32 guide hole; 35 travel driving device; 40, 45, 50 displacement conversion part; 41, 46 elastic member; 41a, 41b, 46a, 46b elastic member; 56 wheel support part; 60 guide protrusion; 61 guide hole; 70, 75 displacement conversion part; 71, 76 wheel support part; 72, 77 shaft; 73, 78 elastic member; 74, 79 bed contact portion; 80 travel driving device; 100, 110, 120, 130, 140, 150, 160, 170, 180 mobile carriage; 200 wheel; 201 wheel support part; 210 displacement conversion part; 220 elastic member; 230 bed guide; 240 omni-wheel; 250 mecanum-wheel.

1. A mobile carriage comprising:
a traveling part;
a wheel provided on the traveling part to allow the traveling part to travel;
a bed supported by the traveling part, the bed being movable in a traveling direction of the traveling part;
a displacement conversion mechanism to displace the wheel relative to the traveling part in accordance with displacement of the bed relative to the traveling part; and
an elastic member to apply a force to return the bed having moved relative to the traveling part, to an initial position before the movement, wherein
the displacement conversion mechanism displaces the wheel relative to the traveling part in a direction of inertial force acting on the bed.

2. The mobile carriage according to claim 1, wherein the displacement conversion mechanism converts displacement of the bed relative to the traveling part into an increased displacement of the wheel relative to the traveling part.

3. The mobile carriage according to claim 1, further comprising:
a wheel support part to support the wheel such that the wheel is movable in the traveling direction of the traveling part, wherein
the displacement conversion mechanism includes a link and a wire, the link being rotatably attached to the traveling part, the link having one end coupled to the wheel support part, the wire connecting an opposite end of the link with the bed.

4. The mobile carriage according to claim 3, wherein
the wheel includes a front wheel and a rear wheel, and
the wheel support part supports the front wheel and the rear wheel such that the front and rear wheels are movable in the traveling direction of the traveling part.

5. The mobile carriage according to claim 3, wherein the elastic member has one end connected with the traveling part, and applies tension to the wire.

6. The mobile carriage according to claim 1, further comprising:
a wheel support part to support the wheel such that the wheel is movable in the traveling direction of the traveling part, wherein
the displacement conversion mechanism includes a first link and a second link, the first link having one end rotatably attached to the bed, the second link having one end coupled to an opposite end of the first link and to the traveling part and an opposite end coupled to the wheel support part.

7. The mobile carriage according to claim 6, wherein
the elastic member has one end connected with the bed and an opposite end connected with the traveling part.

8. The mobile carriage according to claim 1, wherein
the wheel includes a front wheel and a rear wheel;
the bed includes a first inclined face lowering from a rear side of the bed toward a center of the bed, and a second inclined face lowering from a front side of the bed toward the center,
the mobile carriage further comprises a first wheel support part to guide the rear wheel such that rear wheel moves in a direction perpendicular to the first inclined face, and a second wheel support part to guide the front wheel such that the front wheel moves in a direction perpendicular to the second inclined face,
the displacement conversion mechanism includes a first bed contact portion movable along the first inclined face, a second bed contact portion movable along the second inclined face, a first shaft connecting the first bed contact portion with the first wheel support part, and a second shaft connecting the second bed contact portion with the second wheel support part, and
the elastic member includes a first elastic member to press the first bed contact portion against the first inclined face, and a second elastic member to press the second bed contact portion against the second inclined face.

9. The mobile carriage according to claim 8, wherein
at least one of the first shaft and the first wheel support part is capable of extending and contracting with movement of the bed relative to the traveling part, and
at least one of the second shaft and the second wheel support part is capable of extending and contracting with the movement of the bed relative to the traveling part.

10. The mobile carriage according to claim 1, wherein
the traveling part includes a guide part on which the bed is mounted, and a base part to support the guide part such that the guide part is movable in a vertical direction,
the bed is supported by the guide part to be movable in the traveling direction of the traveling part, and
the mobile carriage further comprises a third elastic member disposed between the bed and the base part, to apply a force to return the bed having moved relative to the guide part, to the initial position before the movement.

11. The mobile carriage according to claim 10, wherein
the third elastic member is plurally disposed so as to provide different spring stiffnesses in the traveling direction of the traveling part, depending on a vertical position of the bed.

12. The mobile carriage according to claim 1, wherein the bed is guided in a downward convex arc relative to the traveling part.

13. The mobile carriage according to claim 1, further comprising a travel driving device including: a first motor; and a driving wheel to be driven and rotated by the first motor.

14. The mobile carriage according to claim 1, wherein the wheel includes a plurality of omnidirectional wheels,
the mobile carriage further comprises a plurality of wheel support parts to support the plurality of wheels such that the wheels are movable in different directions relative to the traveling part, and
each of the displacement conversion mechanism and the elastic member is plurally provided in correspondence to the plurality of wheel support parts.

15. The mobile carriage according to claim 14, wherein the omnidirectional wheels are omni-wheels or mecanum-wheels, and
the mobile carriage further comprises a plurality of second motors to drive and rotate the omnidirectional wheels.
